(19) United States
(12) Patent Application Publication
(10) Pub. No.: US 2016/0078446 A1
(43) Pub. Date: Mar. 17, 2016

(54) METHOD AND APPARATUS FOR SECURE ONLINE CREDIT CARD TRANSACTIONS AND BANKING

(71) Applicant: Jonathan Trostle, Vancouver, WA (US)

(72) Inventor: Jonathan Trostle, Vancouver, WA (US)

(21) Appl. No.: 14/855,155

(22) Filed: Sep. 15, 2015

Related U.S. Application Data
(60) Provisional application No. 62/050,459, filed on Sep. 15, 2014.

(51) Int. Cl. G06Q 20/40; G06Q 40/00

(52) U.S. Cl. CPC G06Q 20/4016; G06Q 40/12; G06Q 2220/10

(57) ABSTRACT

A hardware based system and method that detects fraudulent financial activity originating from malicious programs on a user's computer and ensures that user sensitive information is not accessible to programs on the user's computer. The system includes an untrusted service process on the user's computer, a back end server/cloud based infrastructure, and a user device that records the user's computer at the time the transactions are executed. The device has a minimal TCB (Trusted Computing Base) and is trusted to carry out its functions. The device stores sensitive user information and enters this information into secure channels ensuring that the user's computer does not have access to this information. Periodic statement review is accomplished by comparing the device's record of transactions against the record in the payment system and discrepancies result in notifications to the user. The payment system entities may be unaware of the system, or they may exchange information with the system in order to obtain security benefits including fraud detection and tokenization services.

### CROSS-REFERENCE TO RELATED APPLICATION(S)

The present application derives priority from U.S. Provisional Patent Application 62/050,459 filed 15 Sep. 2014.

### BACKGROUND OF THE INVENTION

1. Field of the Invention

The present invention relates to online credit card transactions/online banking and, more particularly, to a system and method for securing online credit card transactions and/or online banking using a device that interfaces with a user's existing computing infrastructure in order to protect against attacks even where the user's existing computer infrastructure has been hijacked.

2. Description of the Background

Although online shopping and online banking (online commerce) enable significant cost savings and provide consumers with increased convenience which potentially leads to increased sales and profits, lack of security remains a significant roadblock. In particular, there are many consumers who will not engage in online banking, and many online purchases never occur due to security concerns. Furthermore, security experts agree that there will continue to be ongoing discovery of “zero day” (new) vulnerabilities which can be used to compromise user computers (e.g., desktops, laptops, and smartphones). A compromised computer can be completely controlled by an adversary.

Even though the bank website may be up to date regarding code patches and usage of security mechanisms, and an encrypted authenticated channel may be used between the user computer and the bank website, the user's computer remains prone to attack in this triad. The user cannot be assured of security if their own computer is compromised.

Alarmingly, a high percentage of user computers (e.g., home computers) are compromised. A study in the 2007 time frame estimated that 10% of home computers were compromised, i.e., controlled by an attacker. Existing commercial off-the-shelf operating systems such as Windows™ and Linux™ are too large and complex for assurance claims regarding security. Mobile phone operating systems are as complex as PC operating systems and have also been subjected to numerous attacks. Thus the security protections provided by user computers are limited and give ample opportunity for criminals.

For example, consider a user's defense against fraudulent credit card transactions. The user can inspect their end-of-month statement for any discrepancies. However, if the user reads the statement online, then the statement is no more trustworthy than the user's computer. In other words, the adversary will be able to cover their tracks and can perform fraudulent credit card transactions without being detected by the user. The same holds for online banking. Thus there is a need for increased security for online commerce. A critical requirement is that an adversary in control of a compromised user computer should not be able to commit a fraudulent transaction without being detected in a timely manner, and that user secrets not be exposed to a compromised computer.

Password based authentication over an encrypted channel (the TLS/SSL cryptographic protocol is typically used) gives no protection against the compromised user computer as described above. An attacker can capture the user password and commit fraudulent transactions. Two factor authentication, sometimes using one time passwords, still allows an adversary to conduct fraudulent transactions including misrepresenting the payment amount, and tricking the user into making additional unwanted purchases.

For users that possess chip and pin cards, an additional device can be used to ensure a higher level of security (Chip TAN or Card TAN) for online banking. This technology requires the bank website to be modified and thus would not be easily deployable for credit card transactions. Furthermore, the user must check the transaction details and it is not hard to create a fraudulent transaction which appears like the desired transaction.

Thus there is a need to devise more secure solutions for online commerce.

### SUMMARY OF THE INVENTION

It is therefore, an object of this invention to provide a more secure method and apparatus for online credit card transactions and banking.

It is another object to provide a secure method and apparatus for online credit card transactions/banking that is easily deployable and does not require merchants, issuers, or networks to change their infrastructure.

It is another object to provide a secure method and apparatus for online credit card transactions/banking that does not depend on the user's ability to verify transaction details.

It is another object to provide a secure method and apparatus for online credit card transactions/banking that does not allow an adversary in control of a compromised user computer to be able to commit a fraudulent transaction without being detected in a timely manner.

It is another object to provide a secure method and apparatus for online credit card transactions/banking that increases the convenience of the online payment experience for users.

It is another object to provide a secure method and apparatus for online credit card transactions/banking that enables users to opt in for sharing their purchase history in return for financial incentives.

It is another object to provide a secure method and apparatus for online credit card transactions/banking that allows merchants to gain immediate knowledge regarding increased security that is being provided for some transactions.

It is another object to provide a secure method and apparatus for online credit card transactions/banking that enables users to be able to view their online banking statement on their computer with the knowledge that it is authentic.

According to the present invention, the above described and other objects are accomplished by providing a system and methods for constructing online banking and payment schemes that are efficient, usable, and maintain security even when the user's computer (e.g., personal computer or smartphone) is compromised. The new methods enable schemes that provide the following features: (1) online banking and online credit card transactions without disclosure of passwords or credit card numbers to the user's computer; (2) online banking and online credit card transactions without modification to the merchant, acquirer, credit card network, or issuer software or computing infrastructure; (3) online statement review with the assurance that fraudulent transactions are visible to the user in the statement; (4) users and participating merchants receive immediate information on whether the transaction is fraudulent (e.g., did the user intend to authorize the transaction); (5) a tokenization service for participating merchants in order to limit the impact of security incidents for the merchant site; (6) the user does not have to manually enter billing address, credit card number, etc., into their personal computer thus increasing convenience for the user; (7) opt-in option for the user to share their purchase history in exchange for future discounts on purchases; (8) protects social security numbers and other sensitive information in the same manner; (9) simple installation and initialization procedure.

The new techniques that enable these features include a device 100 comprising a custom built secure operating system with a minimal sized TCB (Trusted Computing Base). The device 100 records the user interface as seen by the user and thus acts as a trusted reference point for comparing against the transaction records from the payment system. Thus a compromised system engaging in fraudulent transactions will be detected. The device 100 also acts as a trusted cryptographic hardware security module so that sensitive information such as credit card numbers, bank passwords, or other user secrets are not exposed to the user's computer. A back end server 108 may be incorporated and it can exchange information with the device 100, merchants, and other financial system entities.

In one embodiment of the present invention, a device 100 including hardware is used to provide security services that will overcome security weaknesses and vulnerabilities associated with the user's computer including any programs on said computer. The device 100 includes a custom built secure operating system with a minimal sized TCB (Trusted Computing Base).

In one embodiment of the present invention, a back end server 108 is used to compare data received from the device 100 with data received from other sources in order to discover discrepancies that are associated with fraudulent transactions. The server may process security critical information in a Trusted Computing Base (TCB) which provides assurance against security attacks. The back end server 108 may also exchange information with merchant servers including providing tokenization services, payment authorization data, and fraud detection. The back end server 108 may also interact with banking infrastructure, credit and debit card issuers, payment networks, and acquirers.

In one embodiment of the present invention, a service process (or service) 106 runs on the user computer and acts to forward communications from and to the device 100. The service process 106 can also interact with the user's browser and other elements of the user's interface. The service process may forward communications from and to the back end server 108.

In one embodiment of the present invention, the service 106 also performs SSL interception and thus has access to all HTTP over TLS/SSL communications (HTTPS) from programs on the user's computer. The service 106 may proxy all user communications, the service 106 may start to proxy communications just prior to user financial or other sensitive transactions, or the service 106 may answer all DNS queries and only proxy communications where the peer is the bank or other financial institution. As an alternative to SSL interception, the service 106 may perform SSL stripping which involves replacing https URL's in the documents with http URL's.

One embodiment of the present invention provides security features with no changes to any code or payment system infrastructure. The user checks monthly statements in order to detect any fraudulent transactions. The device 100 records the statement and forwards the statement to the back end server 108 along with a copy of the statement obtained directly from the issuer or bank. The back end server 108 compares the two versions and notifies the user of any discrepancies.

In one embodiment of the present invention, the device 100 performs cryptographic operations and enters the stored user information into the encrypted channel, thus eliminating the access of the user's computer to sensitive user information.

In one embodiment of the present invention, the device 100 sends information to the back end server 108 about financial transactions on the user's computer. The credit/debit card number and/or security code fields or bank password field in the payment page include a number that links the transaction received by the merchant or bank server (server) and the information sent by the device 100. The server and the back end server 108 exchange information or perform joint computations that allow at least one of the two entities to learn whether the transaction may be fraudulent. Further action can be taken depending on this result.

In one embodiment of the present invention, the device 100 sends information to the back end server 108 about financial transactions on the user's computer. The credit/debit card number and/or security code fields or bank password field in the payment page include an encryption of a timestamp using an AEAD algorithm that also integrity protects transaction information. The timestamp is included in the information sent by the device 100 and links these two sets of information. The server and the back end server 108 exchange information or perform joint computations that allow at least one of the two entities to learn whether the transaction may be fraudulent. Further action can be taken depending on this result.

In one embodiment of the present invention, a verbal command (the fill command) from the user instructs the device 100 to send information about the user's screen to the service 106 (running on the user's computer) which will then use that information to instruct the user's browser to automatically fill in user input text fields thus saving the user from having to enter the text manually (e.g., via the keyboard.)

In one embodiment of the present invention, the fill command is used, another command can be used to record information about the user's statement, another command can be used to record the user's submission of the payment page, and another command can be used to stop recording.

In one embodiment of the present invention, the device 100 may record information by photographing, videotaping, or audio recording the user interface.

In one embodiment of the present invention, the device 100 may recognize statements or payment pages and automatically record information without receiving external commands.

In one embodiment of the present invention, the service program 106 running on the user's computer proxies TLS/SSL hand-shake messages between the device 100 and the merchant or banking server (target server). A secure channel is established between the device 100 and the target server. A separate second secure channel is set up between the user's browser 114 or other interface program and the service 106. A third secure channel protects the communications between the device 100 and the service 106. The service 106 can proxy data between the first two secure channels but must use the device 100 for the cryptographic operations for the first secure channel. The device 100 may enter sensitive user information such as credit card numbers, passwords, or social security numbers into the appropriate fields prior to applying the cryptographic operations. In this process, the service 106 as well as other programs on the user's computer does not have access to the sensitive user information. The sensitive information is communicated to the target server and is protected by the first secure channel. An alternative cryptographic protocol to TLS/SSL or an alternative certificate format other than X.509 can be used.

In one embodiment of the present invention, verification that the certificate name can be derived from the name in the browser uniform resource locator or user interface is accomplished via the device 100 forwarding the certificate name to the back end server 108 along with information about the financial transaction as depicted on the user interface. The back end server 108 can compare the naming information from the two sources and take further action depending on whether there is a derivation. If no derivation exists, the transaction may have a higher chance of being rejected. The back end server 108 can also validate the certificate chain. Optionally, the device 100 may perform these tasks.

In one embodiment of the present invention, the back end server 108 interacts directly with the card issuer server and/or the banking server as well as the target server site (endpoint for communications from the user's computer). The back end server 108 delivers information to the target server site regarding the transaction, including whether the transaction should be authorized.

In one embodiment of the present invention, the back end server 108 interacts directly with the banking infrastructure or the credit/debit card network, eliminating the need for communications with intermediate payment gateways and/or acquirers.

In one embodiment of the present invention, initialization of the device 100 and system is accomplished by the user entering information, such as name, credit/debit card numbers, security code, username, passwords, social security number, billing address, mobile phone number, and email address into the device 100 and installing the service 106 on their computer.

In one embodiment of the present invention, initialization of the device 100 and system is accomplished by the user entering information, such as name, credit/debit card numbers, security code, username, passwords, social security number, billing address, and email address into the computer and installing the service 106 on their computer.

In one embodiment of the present invention, the device 100 communicates with the service 106 via Bluetooth networking.

In one embodiment of the present invention, the device 100 communicates with the service 106 via wireless LAN networking.

In one embodiment of the present invention, the device 100 communicates with the service 106 via wired networking with the computer.

In one embodiment of the present invention, the user checks banking and/or credit/debit card statements that are delivered by surface mail. The user may check that the transactions are authentic.

In one embodiment of the present invention, the back end server 108 checks/compares banking and/or credit/debit card statements that are delivered by email or another communication protocol to the back end server 108. The back end server 108 may check for discrepancies between the statements and the information sent by the device 100 to the back end server 108.

In one embodiment of the present invention, the device 100 checks/compares banking and/or credit/debit card statements that it obtains from the issuer or bank with the statement derived from recording the user's computer. The device 100 may check for discrepancies between the statements and notify the back end server 108 or user accordingly.

In one embodiment of the present invention, user purchase history is shared with merchants and advertisers based on user opt in. In return, the user receives discounts on future transactions.

In one embodiment of the present invention, the device 100 offloads public key operations or utilizes well known split key techniques in order to shift some of the computation work to a cloud network associated with the back end server 108.

In one embodiment of the present invention, the device 100 shares one or more cryptographic symmetric keys with the back end server 108 in order to provide confidentiality, authentication, and replay detection services (a secure channel) for their communications.

In one embodiment of the present invention, the back end server 108 infrastructure forwards one notification at the end of each statement period with the results from the statement review, over a secure channel to the device 100 and the device 100 displays the notifications to the user.

In one embodiment of the present invention, the back end server 108 infrastructure forwards a notification by surface mail at the end of any statement period where the results from the statement review indicate potential fraudulent activity or another anomaly.

In one embodiment of the present invention, the device 100 is embedded within a watch, a hat, or a pair of glasses.

In one embodiment of the present invention, the device 100 takes sensitive information and uses secret sharing or other secure multiparty computation techniques and sends the sensitive information to multiple servers. For example, the device 100 may share distinct symmetric keys with each of the servers. The device 100 only sends partial information to each server. Thus no single server has the sensitive information. The servers use a multiparty computation protocol in order to compute functions that include the sensitive information as one or more inputs. For example, none of the servers would have a card number but would instead have shares of, or encryptions of, the card number.

In one embodiment of the present invention, the device 100 prevents phishing attacks by ensuring that user passwords are only sent in secure channels to the domain names/URLs that correspond to the domain names/URLs that are configured by the user at initialization. The target domain proves ownership of a certificate (or symmetric key based via successful decryption) in a public based authentication protocol (e.g. TLS/SSL), and the certificate subject or alternate subject names must be derivable from the domain names/URLs stored by the device 100, corresponding to the user passwords and secrets.

In one embodiment of the present invention, the service 106 prevents Cross Site Scripting (CSS) attacks against the user's browser cookies by proxying requests to protected websites and substituting cookie pointers for the actual cookies in the user's browser. The service 106 substitutes the actual cookies in place of the cookie pointers, and vice versa for the reverse direction traffic. The device 100 may store cookies, replacing them in the plaintext with cookie pointers, ensuring that all financial transactions must leverage the device 100 and thus have their protocol bits recorded. Each protocol record can be compared against the corresponding device 100 record.

It is clear to one that is skilled in the art that many of these embodiments can be combined in various ways to obtain a method or system with the resulting combined properties.

### BRIEF DESCRIPTION OF THE DRAWINGS

FIG. 1 is a block diagram showing the present system including the device, the service, and the back end server infrastructure.

FIG. 2 is a block diagram that overviews the merchant transparent system.

FIG. 3 is a block diagram showing the method for protecting secrets from the user's computer in a manner that is transparent to the payment system.

FIG. 4 is a block diagram showing a method for secure statement review.

FIG. 5 is a block diagram showing the merchant transparent system including protection of user secrets, device forwarding of transaction information to the back end server, and statement review.

FIG. 6 is a block diagram showing the method by which we obtain high assurance for the device.

FIG. 7 is a block diagram showing the merchant aware system including the merchant server interacting with our system's back end infrastructure for the purpose of improved fraud detection and tokenization, and use of the random identifier for connecting the two sets of information.

### DETAILED DESCRIPTION OF THE PREFERRED EMBODIMENT

The following description of illustrative non-limiting embodiments of the invention discloses specific aspects and configurations. The embodiments are only examples of the present invention, and the features described below are used to illustrate such embodiments and to provide an overall understanding of the present invention. Thus those skilled in the art recognize that the present invention is not limited to the specific embodiments described below.

Also, the descriptions of components of the present invention that are known to those skilled in the art are omitted for the sake of clarity.

Definitions: “User Computer” refers to the user personal computer (desktop or laptop), tablet, smartphone, or other computing device with a communication capability. Typically the user would conduct financial transactions using a browser program.

“Secure channel” refers to a session between two communication peers that provides initial authentication of at least one peer and also provides confidentiality, authentication, and replay protection services for the data that is sent over the channel.

“Financial transactions” include credit/debit card transactions, online banking, and transactions involving social security numbers.

“User secrets” include credit/debit card numbers, user's merchant passwords, online banking passwords, and social security numbers.

“Merchant transparent” is used to denote solutions that do not require any changes to the merchant systems or other payment entity systems.

“Merchant server” includes both merchant servers and online banking servers.

“IV” stands for initialization vector or a nonce used for data encryption.

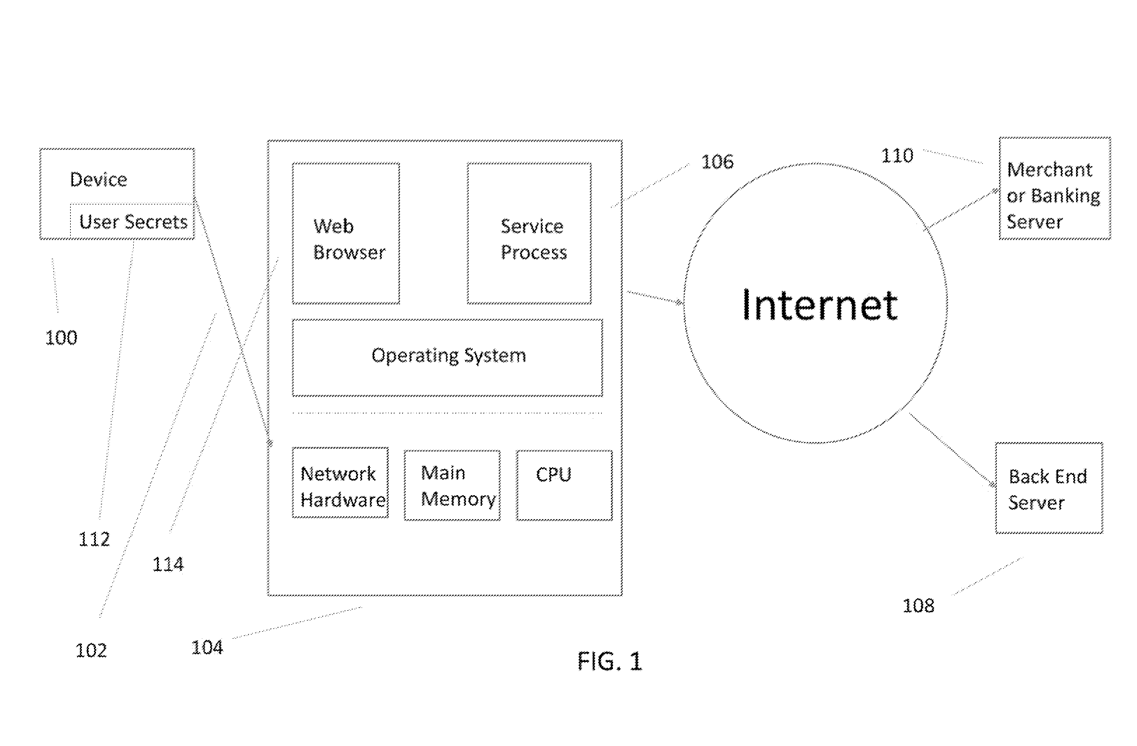

FIG. 1 includes the basic elements of the system including the user's computer 104 which has an Internet connection that allows the user to engage in financial transactions with the merchant or banking server 110, the service process (sometimes referred to as the service) 106 that runs on the user's computer, the device 100, the web browser or other user interface program 114, and the back end server 108 and associated infrastructure for processing information sent by the device 100 and service 106.

The device 100 is a special purpose computer hardware/software system that has a higher level of trustworthiness. It may include, for example, a trusted platform module (TPM) which is an international standard for a secure cryptoprocessor that includes non-volatile storage that is used to store cryptographic keys as well as user secrets 112. In addition to storing user secrets which the device 100 will enter into the appropriate protocol fields and then subsequently encrypt the protocol data unit (PDU), the device 100 performs cryptographic operations for these protocols, and records the web browser or other user interface program 114 of the user's computer 104 for the financial transactions and statement review. These records, which may be in the form of videos, photographs, or audio recordings may be sent to the back end server 108. Optionally, the device 100 may have a display and/or keypad. As an example, the device 100 may be embedded in a watch, a hat, or a pair of glasses.

The device 100 may have its own connection to the Internet (e.g., wireless LAN connection). Also, as a variation, most or all of the functionality of the service process 106 may be replaced and implemented in a process on the device 100. The device 100 may also use Bluetooth or wired networking to connect 102 to the user's computer and then the service will forward all network communications to Internet nodes. Note that back end server 108 may perform OCR to process text from recorded web pages (e.g. device 100 may record web pages and user submission via photo or video).

The device 100 shares a cryptographic symmetric key with the back end server 108 to allow secure channels to be created for protecting communications. Alternatively, public keys can be shared and a public key based cryptographic protocol can be used. Secure channels can be created using any of a number of cryptographic protocols in the literature or standard based cryptographic protocols: IPsec and TLS being two such examples.

The device 100 may also respond to commands from the user. For example, voice commands can be used to cause recording to start or stop (photos or videos). A voice command may also cause the device 100 to alert the service to begin proxying operations. A subsequent voice command may instruct the device 100 to alert the service 106 to fill in some fields in a web form.

Alternatively, the device 100 may communicate information about the user's computer interface and the service 106 may be able to automatically detect when to record information or enter text into a web form. Another command can be used to indicate that only protection of a social security number is needed and no record will be sent to the back end server 108.

The service process 106 may forward communications to and from Internet destinations as a service to the device 100. The service process 106 is untrusted in the following sense: if it fails to carry out its tasks within the system, this failure will be detected by the back end server 108. The service will not have access to user secrets. The service 106 will act as a proxy for some web traffic on the user's computer. The service 106 may proxy all web traffic, or it may only begin proxying in response to a command from the device 100. The service process 106 runs with sufficient privilege on the user's computer so that it may modify DNS configuration and/or browser configuration that will enable the proxy function. The service process 106 may be configured to always proxy for certain DNS domains. The service process 106 will also perform SSL interception (or SSL stripping which removes the TLS channel between the browser and the service); this is explained further below. The service 106 can fill in fields in a web form to ease the burden for the user. Alternatively, the user may leave some web form fields blank and the service process 106 will fill them in. In some cases, it may be acceptable for the service process 106 to initialize the user secrets on the device 100; in this case, the user enters the secrets into their computer and the service process 106 obtains the secrets and forwards them to the device 100. This would be the only case where the service 106 obtains access to the secrets. Alternatively, the user may enter secrets directly into the device 100. The service 106 would also install a trusted root public key into the user's browser 114 at initialization for SSL interception.

The device 100 may store cookies or authentication tokens, replacing them in the decrypted plaintext with cookie pointers, ensuring that all financial transactions must leverage the device 100 and thus have their protocol bits recorded. Each protocol record can be compared against the corresponding device 100 record, partially eliminating the need for obtaining statements from the financial institution. The device 100 replaces the cookie pointers with the actual cookies or authentication tokens in the outgoing plaintexts, prior to encryption and vice versa for the reverse direction traffic. Thus there is a bijective mapping between the cookie pointers and the actual cookies/tokens which is maintained by the device 100.

The back end server 108 performs processing tasks for the system. Records of user financial transactions created by the device 100 are forwarded to the back end server 108. The back end server 108 may process these records using well known techniques such as OCR (Optical Character Recognition). The back end server 108 is involved in statement review and sending notifications as a result of those reviews (see below).

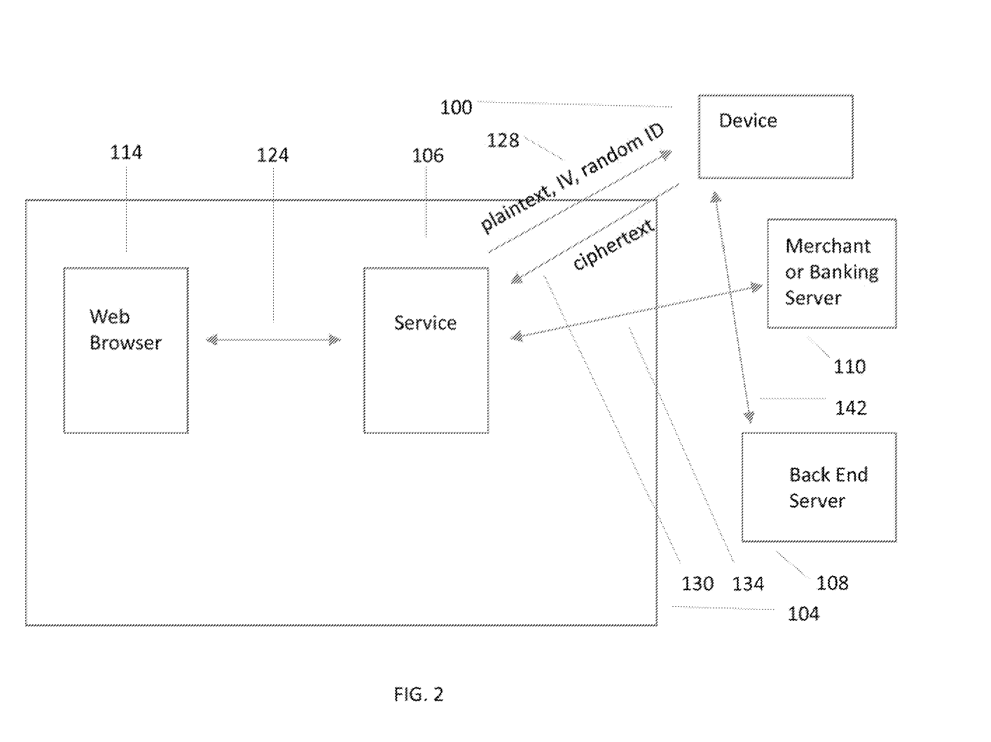

A merchant transparent system is described in FIG. 2. The user computer is 104. In FIG. 2, the service 106 intercepts the DNS query for the merchant server 110 generated by the web browser 114 (URL rewriting is another option here where the service 106 proxies all browser traffic). Based on techniques described for FIG. 1, the web browser connects to the service 106 and a secure channel 124 is established (e.g., using the TLS/SSL protocol). Based on prompts and information sent by the device 100 (e.g., information about the web page), the service 106 may fill in some fields in the web form thus easing the user's task. For a certificate based protocol such as TLS/SSL, the service 106 can use the well-known method of SSL interception. This involves entering the service's public key into the web browser 114 at initialization as a trusted root CA key. The service 106 can then sign certificates corresponding to each target merchant site. The benefit is that the merchant URL that shows in the browser will be derivable from the certificate thus enabling the TLS/SSL (or other certificate based protocol) channel between the web browser 114 and the service 106. (The typical derivation is to ensure that the DNS name from the URL entered into the browser matches the Common Name from the Distinguished Name in the certificate.) Since the service 106 will proxy the secure channel 124 between the device 100 and the merchant server 110, it observes the merchant server 110 certificate during this process. An alternative is to have the service 106 public key CA certificate be signed by an existing trusted root public key in the browser. The cost is a longer certificate chain.

The device 100 handles the secure channel authentication and key establishment protocol with the merchant server 110, so the device 100 has the session keys for encryption and authentication rather than the service 106. The service 106 sends the plaintext, IV, and random identifier 128 to the device 100 and the device 100 returns the ciphertext 130 corresponding to each plaintext. The device 100 may modify (or create) the IV (or nonce) to ensure security. In this case, the modified/new IV or nonce is also returned with the ciphertext. The device 100 records the certificate chain and sends it to the back end server 108 over secure channel 142. The device 100 also sends the record of the purchase including the page displayed in the web browser 114 to the back end server 108 over the secure channel 142, along with the user account information.

In FIG. 2, the device 100 forwards records to the back end server 108. These may be in the form of photos, videos or other media. The records are protected using the secure channel 142 between the device 100 and the back end server 108.

For the sensitive information that the device 100 forwards to the back end server 108, secret sharing or other secure multiparty computation techniques can be used so that the device 100 sends the shares of the sensitive information to multiple servers. For example, the device 100 may share distinct symmetric keys with each of the servers. The device 100 only sends partial information to each server; thus no single server has the sensitive information. The servers use a multiparty computation protocol in order to compute functions that include the sensitive information as one or more inputs. For example, none of the servers would have a card number but would instead have shares of, or encryptions of the card number.

In the merchant transparent solution, the system must periodically perform statement review which includes a comparison of a statement obtained directly from the financial institution and the device 100 record of the statement, or device 100 record of individual transactions, as seen by the user on their computer. This comparison can take place either at the back end server 108 or the device 100. The preferred approach is for the comparison to take place on the back end server 108. If discrepancies are discovered, the user can be notified by surface mail. Alternatively, notifications are sent to the device 100 by the back end server 108 for each statement period and these are displayed to the user. Notifications may also be sent to another device 100 owned by the user, such as a mobile phone. This topic is discussed further below.

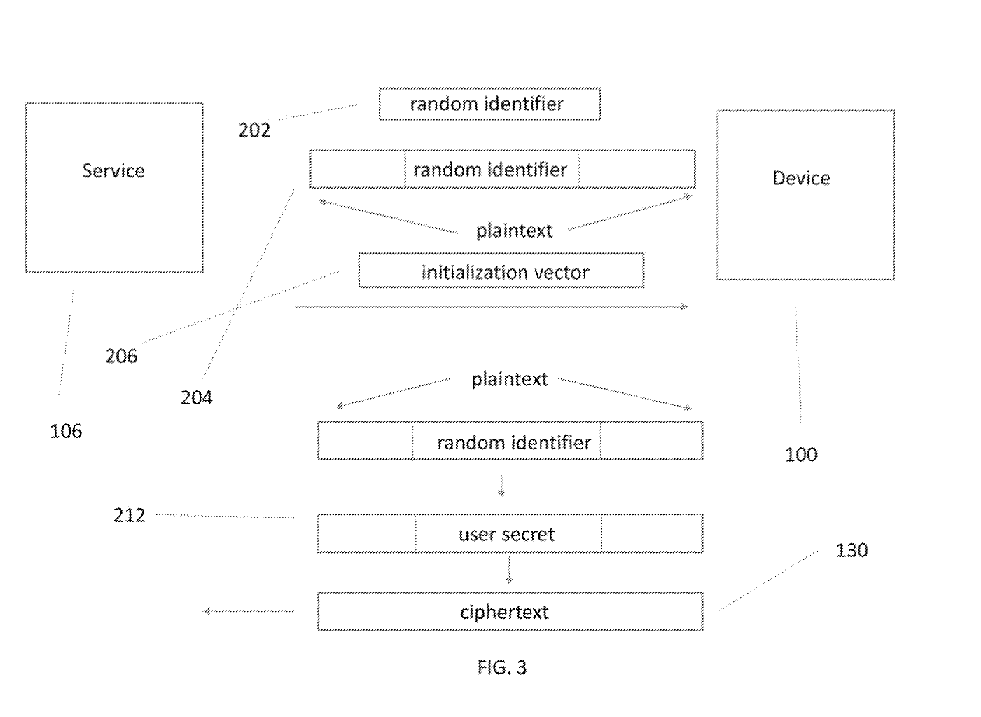

In FIG. 3, the service 106 has filled in the web page banking password, credit/debit card number, user merchant password, and/or security code fields with a random identifier 202, either in the browser or after receiving it over the secure connection between the service 106 and the web browser. Random identifier 202 is sent with the plaintext 204 to the device 100 so the device 100 can easily identify the location in the data to replace with the stored user secret 212. Device 100 may also give length of password to the service 106 so the random identifier will be of the same length as the password. The device 100 encrypts and authenticates the modified plaintext record to obtain the ciphertext 130. In this manner, the financial transaction is completed, and the merchant server and payment system entities are not modified (merchant transparent solution) in order for users to obtain the increased security benefit.

Statement Review

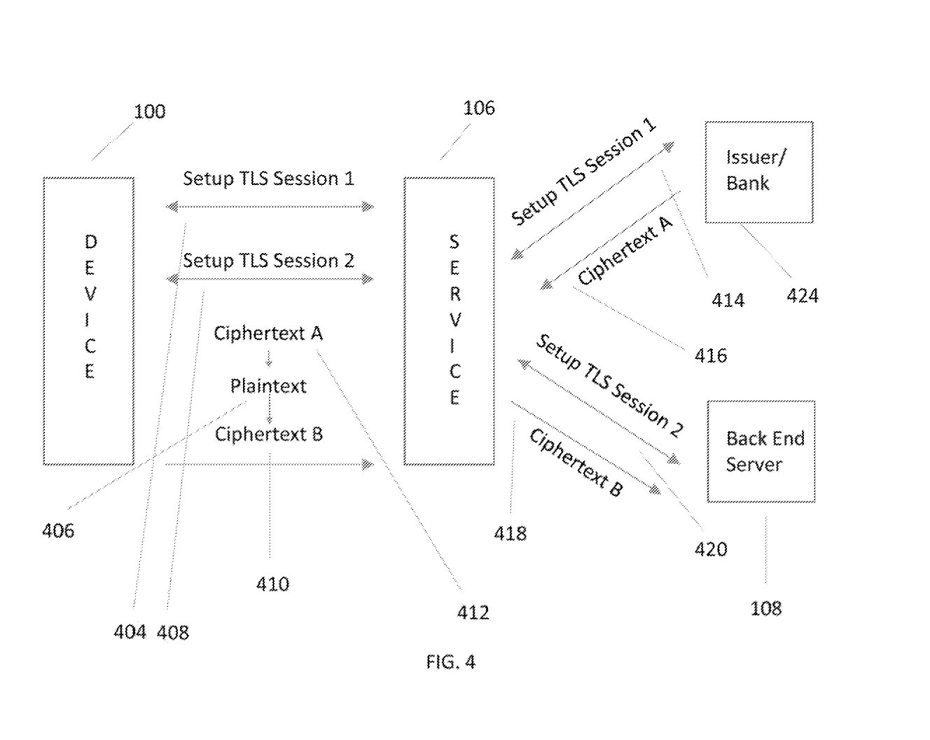

FIG. 4 depicts one algorithm for statement review. The involved entities include the device 100, the service 106, the issuer or bank 424, and the back end server 108. The device 100 sets up two TLS/SSL sessions (but another cryptographic protocol can be used as well): the first TLS session 414, 404 is with the issuer 424; and the 2nd TLS session 420, 408 is with the back end server 108. The service 106 will proxy the TLS session handshake messages between the device 100 and the issuer 424 (and also between the device 100 and the back end server 108). The proxying and two TLS sessions are used to essentially create a virtual TLS session between the back end server 108 and the issuer 424. In this manner, the back end server 108 can obtain the issuer statement from the issuer server 424 without exposing it to the service 106 (or user computer).

As part of user authentication, the device 100 will supply the user password and enter into the appropriate protocol field and perform protocol processing as needed (e.g., encoding). Optionally, some of the processing and logic may be offloaded to the service 106. In particular, the device 100 may decrypt ciphertexts 412 received from the issuer and forward the plaintext 406 to the service 106. The service 106 can then do processing and forward the plaintext back to the device 100. The device 100 then creates the ciphertext 410 that is forwarded 418 to the back end server 108. For password processing, the service 106 can enter a random identifier in the password field as in FIG. 3 and send the random identifier and the modified plaintext to the device 100. Once the device 100 has entered the password, it will not send further plaintexts to the service 106. From that point on, the device 100 decrypts ciphertexts 412 to obtain plaintexts 406, and then re-encrypts to get ciphertexts 410 which are forwarded to the back end server 108. In this manner, we ensure that the service 106 does not have access to the statement.

Although our description above used the TLS protocol for the secure channel between the device 100 and the back end server 108, the secure channel could use a different protocol based on the cryptographic keys that they share.

The above description explains how the back end server 108 may obtain the statement from the issuer 424. The user computer will also obtain the statement and the user will view the statement. This follows the description for FIG. 2 and FIG. 3. In particular, the device 100 will record the statement and forward the record over a secure channel to the back end server 108. The back end server 108 can now compare the two versions of the statement and record any discrepancies. The transactions in the two statements should be identical. If the two statements are not identical, then the user can be notified by surface mail.

Alternatively, the back end server 108 can send the notification to the device 100. In this latter case, a notification would be sent to the device 100 for each statement period including the case where there are no discrepancies. The device 100 would display the notifications to the user (in this case the device 100 must have a display capability). Notifications can be sent to a mobile phone.

The user can also be removed from the statement review process, if the device 100 has recorded all of the transactions. In this case, the back end server 108 has the set of records forwarded by the device 100 for online transactions during the statement period. The device 100 forwards the issuer statement to the back end server 108 as described above in FIG. 4. The back end server 108 can now compare the two sets of information and can record any discrepancies. The transactions can also be processed individually rather than as a batch. This process may be simplified if the issuer statement distinguishes between online and offline transactions, or if the user uses separate accounts for online vs. offline transactions. Alternatively, if the device 100 stores cookies/authentication tokens and manages the user secrets as described above, the need to obtain the statement from the financial institution (payment system) is reduced.

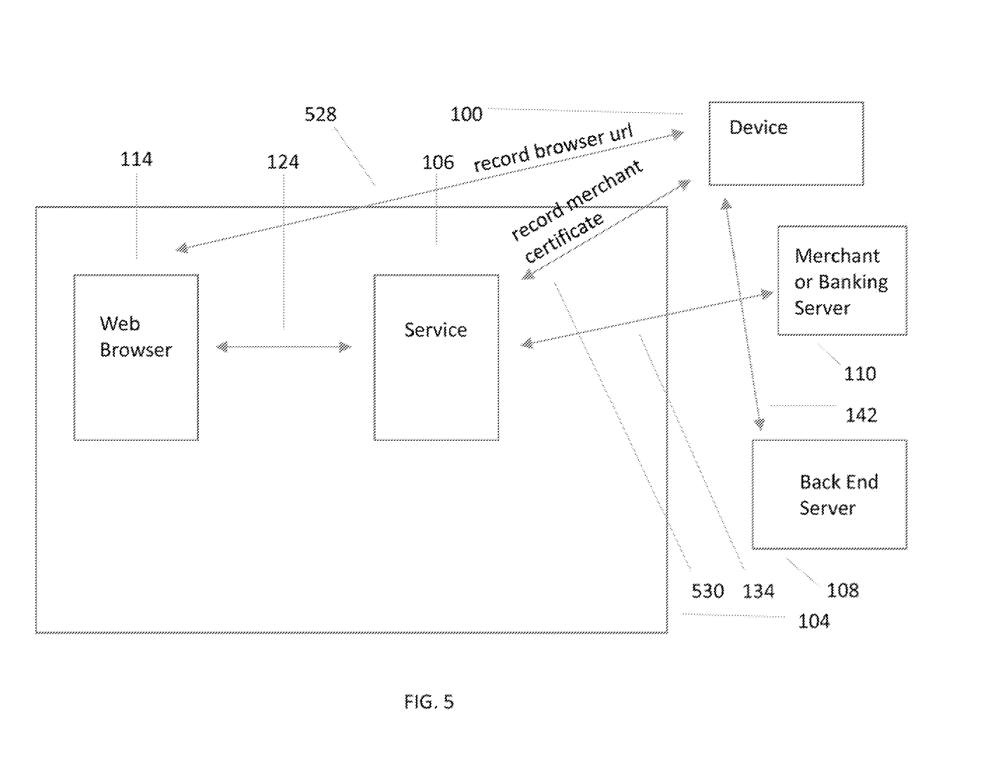

FIG. 5 depicts the mechanism for achieving mutual authentication in a trustworthy manner, even in the case where the user's browser or computer is compromised. The user computer 104 includes the web browser or other user interface program 114 and the service process 106. The secure channel 124 connects the web browser 114 and the service 106 as described in the FIG. 2 description. The device 100 records the web browser URL 528. Also the device records the merchant certificate chain 530 during the TLS handshake messages or other cryptographic protocol initial exchange. The device 100, using the service 106 as a proxy, has established a secure channel 134 with the merchant server 110. The device 100 sends the record of the web browser URL 528 and the merchant certificate over the secure channel 142 to the back end server 108. The back end server 108 processes the record to obtain the domain name in the URL 528, and then checks if the URL domain name is derivable from the merchant certificate name. If so, then mutual authentication succeeds; otherwise, the transaction is logged as fraudulent. The device 100 may also do this processing instead of sending it to the back end server 108.

The device 100 prevents phishing attacks by ensuring that user passwords are only sent in secure channels to the domain names/URL's that correspond to the domain names/URL's that are configured by the user at initialization. The target domain proves ownership of a certificate (or symmetric key based via successful decryption) in a public key based authentication protocol (e.g. TLS/SSL), and the certificate subject or alternate subject names must be derivable from the domain names/URL's stored by the device, corresponding to the user passwords and secrets. The device 100 may send both names to the back end server 108 which can perform the computation and return a yes or no response to the device 100 (or device 100 processes itself). If the answer is yes, then the device 100 can go forward with entering the user secret information into the secure channel. Otherwise the user can be notified via the service 106 that the website is unknown.

The service 106 observes the merchant certificate as part of its proxying of the TLS handshake messages. Therefore, the service 106 is able to present a similar certificate to the web browser 114 as part of the TLS handshake exchange with the web browser 114. Thus the browser's security checks will function in the same manner as if the service 106 was not present.

The device 100 is designed and implemented to carry out its functions in a trustworthy manner. The Trusted Computing Base (TCB) of the device 100 is structured to have minimal size.

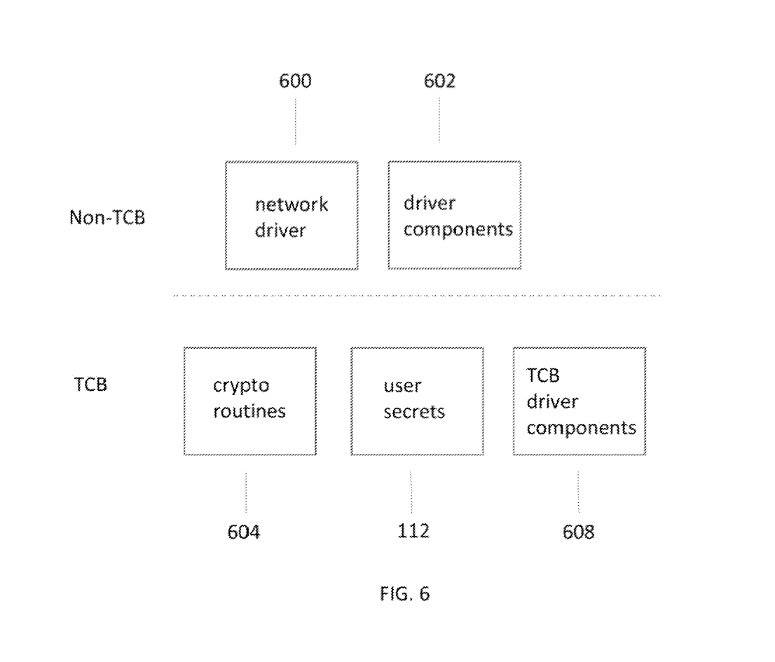

FIG. 6 shows how components of the device 100 may be divided between the TCB and non-TCB parts of the system. For example, the network driver 600 and other driver components 602 reside outside the TCB. The crypto routines 604, the user secrets 112, and the TCB driver components 608 reside within the TCB. The device 100 may also leverage any of the security capabilities of the hardware including enhanced protection for storing secrets and protecting the application level functions from weaknesses in the operating system.

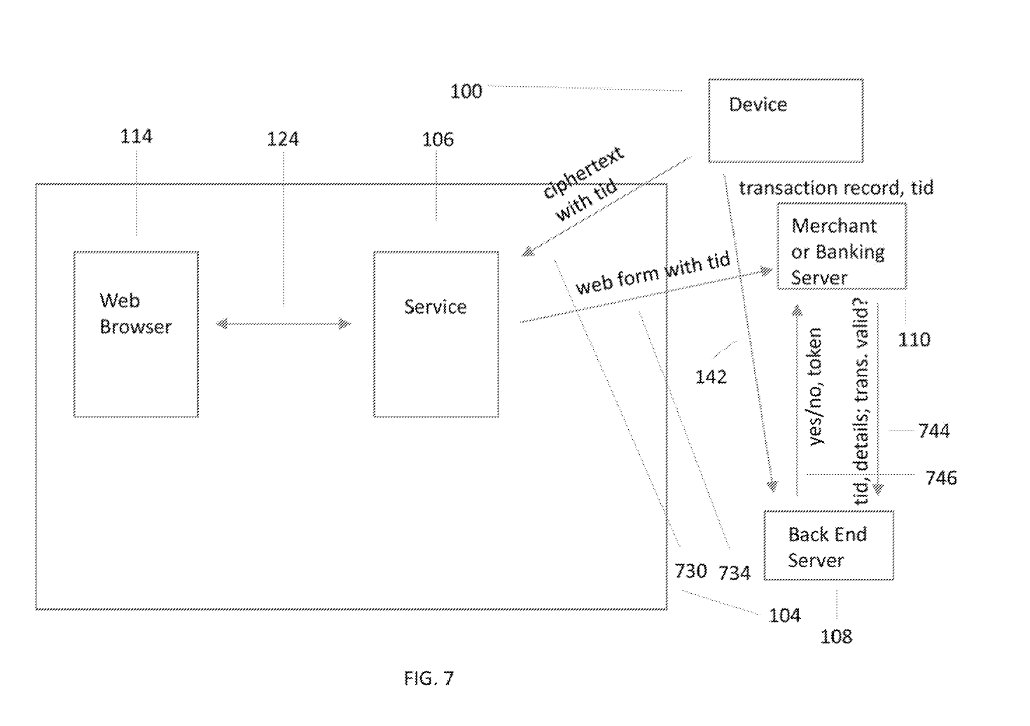

FIG. 7 depicts a credit/debit card/online banking transaction for the merchant aware system, or simply a card number transaction, involving the user computer 104, the web browser 114, the service 106, device 100, and the merchant (or banking) server 110.

For a card number transaction, the card number and security code fields, or password field, can be used to hold a prefix concatenated with a random transaction ID (TID). The service 106 either fills in this type of number into the card number field or password field of the web form or the service displays this number and the user enters it into the field. This information is sent to the merchant server 110 in the web form 734. The device 100 encrypts both its record of the transaction and the user's account information (e.g., timestamp, card number, security code, password, billing address, name, email address, etc.) and at 142 forwards this data to the back end server 108. The random transaction ID can be obtained from the last bits of the ciphertext in 730, or it can be generated as a pseudorandom number. The merchant server 110 forwards it at 744 to the back end server 108 along with the transaction details. The back end server 108 then compares the merchant server information on the transaction to the information sent by the device 100 and returns a validity indicator in 746. Thus the merchant server 110 and the back end server 108 can learn whether a particular transaction is fraudulent in real time allowing the bank or merchant to not authorize the transaction.

Optionally, tokenization of credit/debit card numbers can take place. One method for tokenization is to give each merchant a card number prefix. Then the middle digits of the card number are encrypted using a Format Preserving Encryption algorithm to obtain the middle digits of the token, and the prefix forms the initial digits of the token. The final token digit is the LUHN. Alternatively, the last 4 digits of the card number can be preserved in the token and a smaller number of prefixes can be used. The back end server 108 would return the token in 746. The benefit is that the merchant server 110 does not have access to the account number.

For online banking transactions, the service 106 still performs proxying, SSL interception, and protection of user secrets per the FIG. 2 description. In particular, the banking password is protected from access by the user's computer 104. Bank transactions can be processed as in the card number description above, except the random transaction ID can be placed into an extra field of the application protocol 734 between the service and the banking server. Alternatively, the last bits of the ciphertext that corresponds to the encryption of the web page data can be used as the transaction ID. The banking server 110 has access to this ciphertext. The device 100 also has access to this ciphertext and therefore it can forward the transaction ID per 142 to the back end server 108 as in the description for the card number case above. The banking server 110 uses the transaction ID to exchange or transfer information to the back end server 108, per the description for the card number case above in 744 and 746. In particular, the transaction ID identifies the information that was sent to the back end server 108 by the device in 142.

Target Environments

The encryption process, decryption process, proxy function, substitution of user secrets, and generation of pseudorandom values in the present invention may reside in any peer-to-peer, client-server computer network or sensor network in which two or more computers (host machines) are in wired or wireless communication. An exemplary host machine may include a processor, a memory (e.g. RAM), a bus which couples the processor and the memory, a computer readable storage medium coupled to the processor.

The code described in the embodiments of this invention may reside without restriction in any computer readable storage medium including magnetic devices, disk drives, compact disks (CD's), digital video discs (DVD's), USB drives, or Random Access Memory (RAM).

The algorithms and processing routines that comprise embodiments of this invention may reside on the same host machine or on different host machines. The various host machines could be connected by a network, either wired or wireless.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A computerized security method for detecting fraudulent financial transactions conducted by a program on a computer, comprising the steps of:
providing a trustworthy hardware device (THD);
recording at said THD a user interface on said computer during one or more financial transactions initiated at said computer by a user of said computer;
sending a record of said one or more financial transactions from a source;
comparing the THD-recorded transactions against said record sent from said source to detect a discrepancy; and
detecting a fraudulent transaction conducted by a program on said computer based on a discrepancy.

2. The computerized security method for detecting fraudulent financial transactions according to claim 1, wherein said source is a financial institution.

3. The computerized security method for detecting fraudulent financial transactions according to claim 1, wherein said source is not said computer.

4. The computerized security method for detecting fraudulent financial transactions according to claim 1, wherein said source is said computer.

5. The computerized security method for detecting fraudulent financial transactions according to claim 4, wherein said step of sending to said THD a record of said one or more financial transactions from said computer comprises uploading a plaintext protocol message.

6. The computerized security method for detecting fraudulent financial transactions according to claim 1, wherein said step of sending a record of said one or more financial transactions from a source further comprises sending said record to said THD.

7. The computerized security method for detecting fraudulent financial transactions according to claim 1, wherein said step of sending a record of said one or more financial transactions from a source further comprises sending said record to a remote server.

8. The computerized security method for detecting fraudulent financial transactions according to claim 7, further comprising a step of sending from said THD to said remote server said recorded THD user interface of said computer.

9. The computerized security method for detecting fraudulent financial transactions according to claim 8, wherein said step of comparing the THD-recorded transactions against the sent record is conducted at said remote server.

10. The computerized security method for detecting fraudulent financial transactions according to claim 1, wherein said THD comprises cryptographic security software for encrypting said sent record and said one or more recorded transactions.

11. A security method for detecting a fraudulent online financial transaction conducted remotely between a computer and a financial institution, in which a second record of said financial transaction is stored in memory at said financial institution, comprising the steps of:
providing a trustworthy hardware device (THD);
recording said computer's user interface during said financial transaction at said THD;
downloading said second record of said financial transaction;
comparing the THD recorded interface during said financial transaction against the second record to detect a discrepancy; and
detecting a fraudulent transaction conducted by a program on the user's computer based on a discrepancy.

12. The security method for detecting a fraudulent online financial transaction according to claim 11, wherein said step of downloading said second record of said one or more financial transactions comprises downloading to said THD.

13. The security method for detecting a fraudulent online financial transaction according to claim 11, wherein said step of downloading said second record of said one or more financial transactions comprises downloading to a remote server.

14. The computerized security method for detecting fraudulent financial transactions according to claim 13, further comprising a step of uploading said recorded computer user interface from said THD to a remote server.

15. The computerized security method for detecting fraudulent financial transactions according to claim 14, wherein said step of comparing the THD recorded interface during said financial transaction against the second record downloaded to said THD is conducted at a remote server.

16. The computerized security method for detecting fraudulent financial transactions according to claim 11, wherein said THD comprises cryptographic security software for encrypting said uploaded record and said one or more recorded transactions.

17. The method of claim 1, where said step of providing said THD comprises providing a THD operating system and hardware that enforce memory protection between distinct programs.

18. The method of claim 17, further comprising a substep of partitioning the THD operating system into trusted and untrusted parts and the untrusted parts cannot access the memory of the trusted parts.

19. The method of claim 18, further comprising a substep of placing a network driver and other non-security critical driver components in the untrusted part and utilizing any of the security capabilities of the hardware including enhanced protection for storing secrets and protecting the application level functions from weaknesses in the operating system.

20. The method of claim 1, further including a service program (service) on said user's computer which provides proxying and a communication interface between said THD, banking and merchant servers, remote servers, and a user interface program (e.g., web browser).

21. The method of claim 20, further including having said service program as an endpoint for the secure channel initiated by said user interface program.

22. The method of claim 21, where said service program is using SSL interception or SSL stripping to facilitate the endpoint function.

23. The method of claim 2, further including notifying the user of any discrepancies via an out of band mechanism such as surface mail or communication to a second computer that said user has access to.

24. The method of claim 2, further including notifying the user of any discrepancies via communication to said THD which notifies the user via visual or audio mechanisms.

25. The method of claim 2, further including having the user inspect and validate the statement on said user computer while said THD records to create the THD record.

26. The method of claim 1, further including said THD storing and entering sensitive user information (user secrets) into secure channels ensuring protection of the information from programs on the user's computer.

27. The method of claim 7, where said remote server is designed and implemented to provide trustworthy processing.

28. The method of claim 1, further including initializing the THD including entering sensitive user information (user secrets) and information identifying financial institutions into the THD.

29. The method of claim 28, further including entering said information into the user computer and sending it to said THD.

30. The method of claim 26, further including said THD storing and using cryptographic keys for said secure channels.

31. The method of claim 1, further including said THD responding to vocal/audio commands such as instructions to photograph, begin/stop video, proxy, or automatically input web form data on the user computer.

32. The method of claim 31, further including said THD responding to vocal/audio commands such as proxy or automatically input web form data by sending instructions to the service program on the user computer which fulfills the tasks.

33. The method of claim 1, further including embedding said THD in a pair of glasses.

34. The method of claim 1, further including embedding said THD in a watch.

35. The method of claim 1, further including embedding said THD in a hat.

36. The method of claim 1, further including processing photographs or videos using an OCR algorithm to obtain text for comparing records.

37. The method of claim 1, further including comparing the URL naming data with the naming information from the target server (e.g., banking or merchant server) in order to ensure that said target server is one that matches said URL.

38. The method of claim 37, further including obtaining the target server naming information from a public key certificate as part of a protocol where the target server proves that it has access to the corresponding private key and validating the certificate chain.

39. The method of claim 38, further including validating that the DNS name from the URL matches the Common Name from the Distinguished Name field in the target server certificate.

40. The method of claim 1, further including the THD establishing a secure channel with the issuer/bank in order to obtain the issuer/bank record of transactions for processing and comparison to the THD record of transactions.

41. The method of claim 7, further including the THD establishing secure channels with the issuer/bank and the back end server in order to obtain the issuer/bank record of transactions and sending to the back end server for processing and comparison to the THD record of transactions.

42. The method of claim 7, where secure channels based on public key cryptography use either X.509 certificates or another public key certificate format.

43. The method of claim 1, where said THD is configured as the DNS server or web proxy in order to intercept and play man in the middle between the user interface program and the merchant/banking server, thereby ensuring mutual authentication and entering user secrets into the secure channel if mutual authentication succeeds.

44. The method of claim 20, where said service program is configured as the DNS server or web proxy in order to intercept and play man in the middle between the user interface program and the merchant/banking server, further establishing a secure channel with said THD, thereby ensuring mutual authentication and having said THD enter user secrets into the secure channel between itself and the merchant/banking server if mutual authentication succeeds.

45. The method of claim 26, further including the THD storing the user's national identifier (e.g., social security number) and entering it into secure channels.

46. The method of claim 26, further including the THD communicating with the service via wired or wireless networking.

47. The method of claim 7, further including sending notifications from the back end server to said THD regarding the status of previous transactions and said THD notifying the user.

48. The method of claim 1, further including notifying the user by surface mail if any discrepancies arise between various transaction records, or notifying the user periodically to inform the user of the status for the previous period.

49. The method of claim 7, further including having the THD applying secret sharing or other secure multiparty computation techniques to sensitive data and sending parts of the sensitive information to multiple servers; the servers using a multiparty computation protocol for computing functions that include the sensitive information as one or more inputs.

50. The method of claim 28, further including said THD ensuring that user secrets are mapped to domains so that each user secret is only submitted into the secure channel corresponding to the correct target domain, and establishing the target domain during the initial mutual authentication protocol.

51. The method of claim 37, further including ensuring that any hierarchical naming information for the target server matches the pre-configured information for that domain name (e.g., higher level certificates in the certificate chain including root keys).

52. The method of claim 30, further including said THD performing cryptographic operations with symmetric keys including modifying/creating an IV or nonce for plaintexts that it creates or which are submitted by the user computer, and returning the IV or nonce together with the ciphertext to itself or the user computer.

53. The method of claim 26, further including the user computer sending random identifiers along with a plaintext to said THD where the random identifiers are also embedded in the plaintext in the locations where the user secrets should be placed, and said THD replacing each random identifier with the corresponding user secret.

54. The method of claim 7, further including entering a transaction ID (TID) into the web form linking the data sent to the merchant/banking server with the data sent to the remote server which can then subsequently exchange information to determine the validity of the transaction in an expedited manner allowing the merchant/banking server to reject authorization for the transaction in case of a discrepancy.

55. The method of claim 54, further including the service process entering the TID on the user computer.

56. The method of claim 54, further including displaying the TID to the user who enters it into the user computer.

57. The method of claim 54, further including the THD entering the TID prior to encryption.

58. The method of claim 54, further including selecting the last bits of the ciphertext from the encryption of the user account related information on the THD as the TED.

59. The method of claim 54, further including the back end server returning a token instead of a card number or account number to the bank/merchant server, and the token mapping to a card number or account number, where the benefit is that the bank/merchant server does not have access to the card or account number.

60. A security method for detecting a fraudulent financial transaction conducted remotely between a computer and an ecommerce entity (bank or merchant server), comprising the steps of:
providing a trustworthy hardware device (THD);
recording said computer's user interface during said financial transaction at said THD in order to create a first record of said financial transaction;
storing user secrets in memory of said THD;
establishing a secure encrypted and authenticated communication channel between said THD and said ecommerce entity;
entering user secrets into said secure encrypted and authenticated communication channel between said THD and said ecommerce entity;
sending plaintext of said financial transaction from said computer to said THD;
creating a second record of said financial transaction from said plaintext;
comparing said first record against said second record to detect a discrepancy;
and detecting a fraudulent transaction conducted by a program on the user's computer based on a discrepancy.

61. The method of claim 60, further including having said THD storing http cookies or other authentication tokens returned by said banking/merchant server and replacing each such object with an identifier prior to sending to the user computer, and replacing the identifiers with the cookies or other authentication tokens before forwarding to servers.

62. The method of claim 61, further including sending the two records to a remote server for comparison.

63. A system for detecting fraudulent financial transactions conducted by a program on a computer, comprising:
a trustworthy hardware device (THD) including a computer processor and a non-transitory storage media storing cryptographic keys and user secrets, and a recorder for recording a user interface of said program on said user's computer by any one or more of videos, photographs, and audio recordings;
a source for providing a record of one or more financial transactions initiated at said computer by a user of said computer; and
means for uploading said record of financial transactions from said source and comparing said record to said recorded user interface and detecting a fraudulent transaction conducted by said program on said computer based on a comparison discrepancy.
